(19) United States
(12) Patent Application Publication
(10) Pub. No.: US 2025/0170963 A1
(43) Pub. Date: May 29, 2025

(54) In-Vehicle Locking Safe

(71) Applicant: Wen Yi, Shenzhen (CN)

(72) Inventor: Wen Yi, Shenzhen (CN)

(21) Appl. No.: 18/522,827

(22) Filed: Nov. 29, 2023

(51) Int. Cl. B60R 7/08; E05G 1/024; E05G 1/026

(52) U.S. Cl. CPC B60R 7/087; E05G 1/024; E05G 1/026

(57) ABSTRACT

An in-vehicle locking safe includes a top panel, a front panel, a rear panel, and a side panel. The top panel comprises a front end and a rear end. The front panel comprises a top end and a bottom end. The rear panel comprises a top end and a bottom end. The side panel comprises a top end, a bottom end, a font end, and a rear end. The front end of the top panel is attached to the top end of the front panel. The rear end of the top panel is attached to the top end of the rear panel. The top end, the font end, and the rear end are attached to lateral ends of the top panel, the front panel, and the rear panel, respectively, to form an accommodation space. The top panel further comprises a lid.

### FIELD OF THE INVENTION

The present invention relates generally to in-vehicle storage apparatuses. More specifically, the present invention is an in-vehicle locking safe that can be conveniently installed in an existing center console storage compartment. The present invention is specifically designed for automobiles. However, the present invention is not limited to this option, and it may further be adapted for different purposes.

### BACKGROUND OF THE INVENTION

Some vehicles are equipped with locking compartments or locking safes to store valuables. These locking safes are traditionally located within a console of the vehicle (e.g., center console, trunk console) or a glovebox compartment. Such conventional locking safes are difficult to install, and can easily be removed, detached, or stolen from the vehicle. Moreover, the installation of the conventional locking safes usually requires removal of the tray in the console storage compartment. In addition, users may be required to drill holes in the console to secure the conventional locking safes.

Therefore, it is an objective of the present invention to provide an in-vehicle locking safe that overcomes the problems set forth above.

### SUMMARY OF THE INVENTION

The present invention discloses an in-vehicle locking safe that comprises a top panel, a front panel, a rear panel, and a side panel. The top panel comprises a front end and a rear end. The front panel comprises a top end and a bottom end. The rear panel comprises a top end and a bottom end. The side panel comprises a top end, a bottom end, a font end, and a rear end. The front end of the top panel is attached to the top end of the front panel. The rear end of the top panel is attached to the top end of the rear panel. The top end, the font end, and the rear end are attached to lateral ends of the top panel, the front panel, and the rear panel, respectively, to form an accommodation space. The top panel further comprises a lid.

One or more of the following features may be included. The lid further comprises a locking mechanism. The top panel further comprises a front portion and a rear portion, and the front portion tapers toward the front end of the top panel. The front panel further comprises a front cutout. The front panel further comprises a top portion and a bottom portion, and wherein the top portion is inclined outward from the top end of the front panel, while the bottom portion is inclined outward from the bottom end of the front panel. The front panel further comprises a front side extension that extends sideward from the bottom end of the front panel, adjacent to the side panel. The front panel further comprises a front top extension that extends upward from the top end of the front panel. The rear panel further comprises a rear cutout. The rear panel further comprises a top portion and a bottom portion. The top portion is inclined outward from the top end of the rear panel, while the bottom portion is inclined outward from the bottom end of the rear panel. The rear panel further comprises a rear side extension that extends sideward from the bottom end of the rear panel, adjacent to the side panel. The rear panel further comprises a rear top extension that extends upward from the top end of the rear panel.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

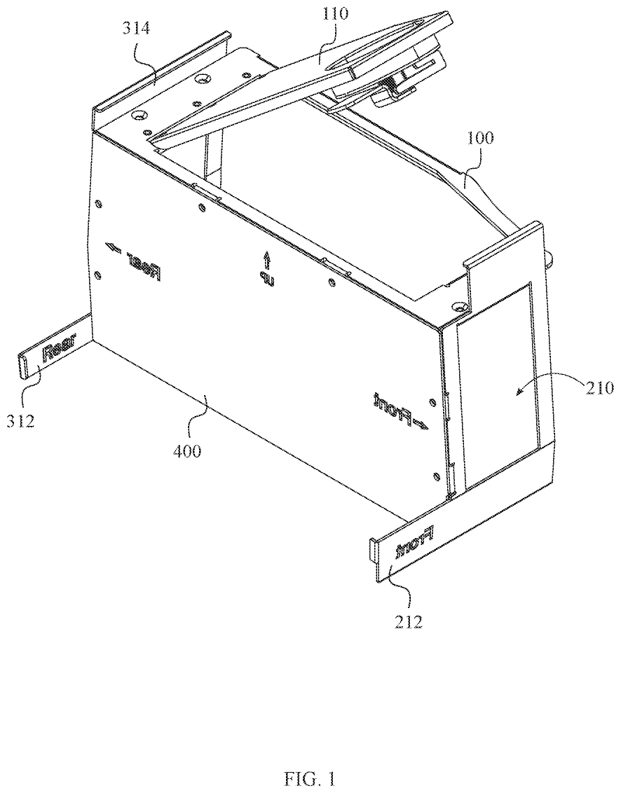

FIG. 2 depicts another perspective view of the present invention.

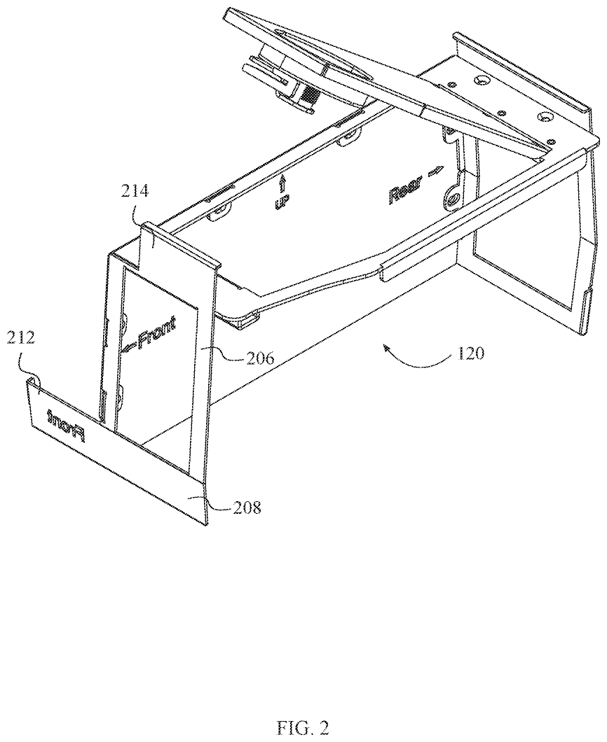

FIG. 3 depicts a front view of the present invention.

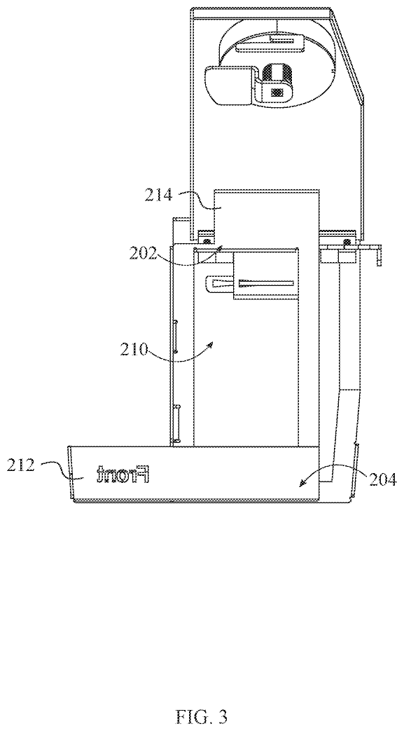

FIG. 4 depicts a rear view of the present invention.

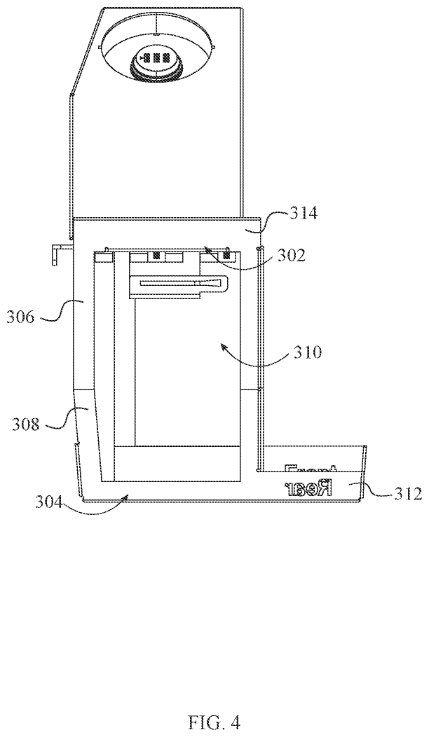

FIG. 5 depicts a top view of the present invention.

FIG. 6 depicts a left view of the present invention.

FIG. 7 depicts a right view of the present invention.

FIG. 8 depicts an exploded view of the present invention.

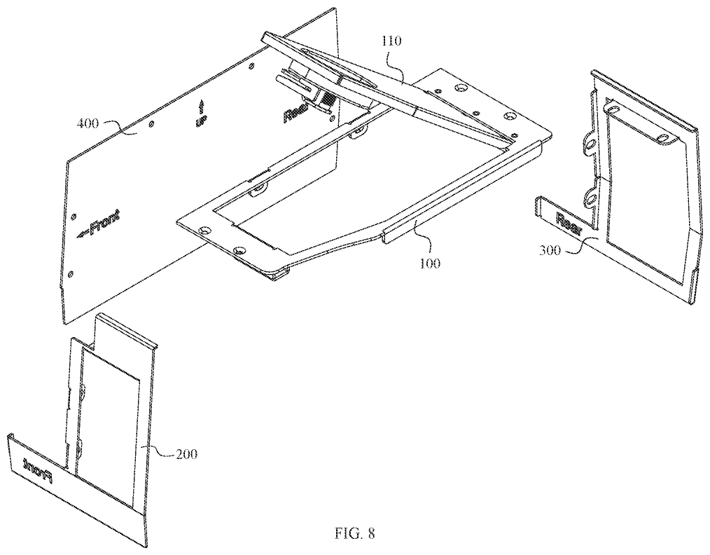

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of in-vehicle locking safes, embodiments of the present disclosure are not limited to use only in this context.

The present invention is an in-vehicle locking safe that is specifically designed to be installed in an automobile center console storage compartment. It is an aim of the present invention to provide an in-vehicle locking safe that can be easily installed without using additional fasteners. It is another aim of the present invention to provide an in-vehicle locking safe that is simple in structure, inexpensive to manufacture, and easy to use.

Referring now to the figures of the present disclosure. The in-vehicle locking safe of the present invention comprises a top panel 100, a front panel 200, a rear panel 300, and a side panel 400. The top panel 100 comprises a front end 102 and a rear end 104. The front panel 200 comprises a top end 202 and a bottom end 204. The rear panel 300 comprises a top end 302 and a bottom end 304.

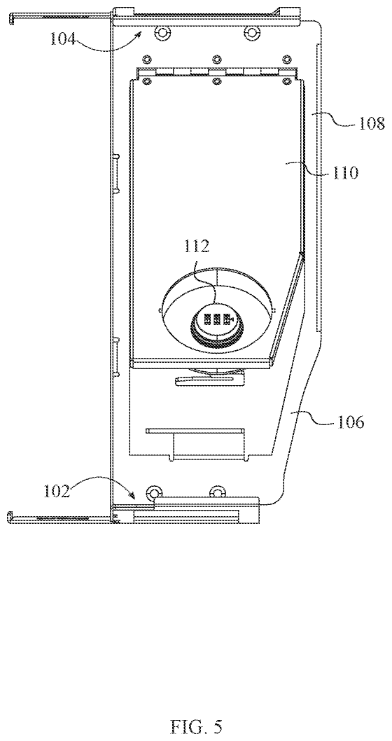

The top panel 100 is configured to form a top wall of the locking safe. It should be noted that the top panel 100 can be of any shape, size, material, features, type or kind, orientation, location, quantity, components, and arrangements of components that would allow the present invention to fulfill the objectives and intents of the present invention. The front end 102 of the top panel 100 may be attached to the top end 202 of the front panel 200, while the rear end 104 of the top panel 100 may be attached to the top end 302 of the rear panel 300. It should be noted that the front end 102 and the rear end 104 of the top panel 100 may be attached to the top end 202 of the front panel 200 and top end 302 of the rear panel 300 via any suitable means, including but not limited to adhesives, mechanical fasteners (e.g., screws, nuts, bolts, etc.), welding, etc. In one embodiment, the top panel 100 further comprises a lid 110. In a preferred embodiment, the lid 110 is a hinged lid. In one embodiment, the lid 110 further comprises a locking mechanism 112. The locking mechanism 112 is operatively coupled with, for example, the top panel 100. The locking mechanism 112 may include a digital padlock, a physical keyed lock, a combination lock, a mortise lock, an electronic lock, etc., and/or any other locking mechanism known in the art. The locking mechanism 112 may be any type or style of lock and may be accessible in any acceptable manner. For example, The locking mechanism 112 may be unlocked or made accessible by moving one or more dials into a particular configuration, selecting one or more numbers/letters in a specific pattern on an operatively coupled keypad (e.g., including physical and/or virtual keypads, connected through a hardware connection, a wired and/or wireless connection, and the like). In a preferred embodiment, the top panel 100 further comprises a front portion 106 and a rear portion 108. The front portion 106 may taper toward the front end 102 of the top panel 100, as best shown in FIG. 5. In this embodiment, the rear portion 108 may or may not be of constant width to better conform to the interior contour of the center console storage compartment.

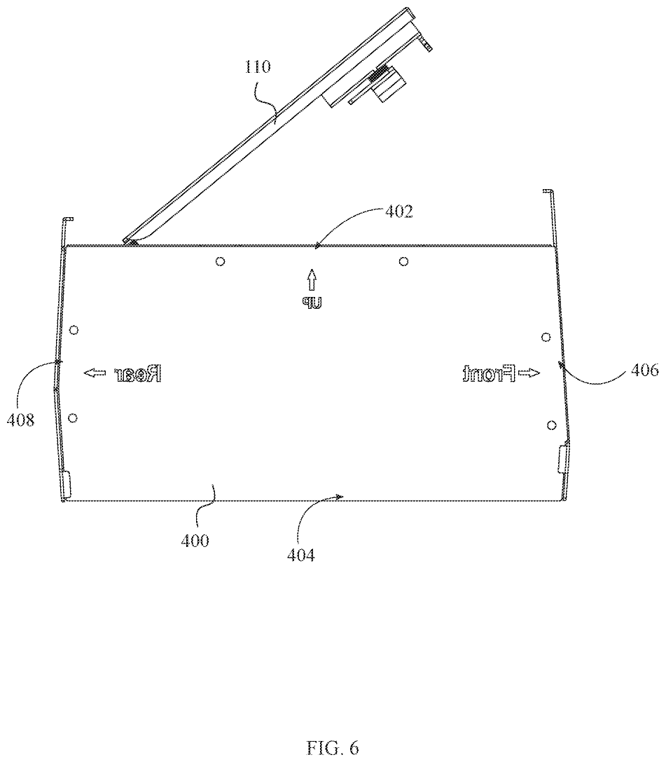

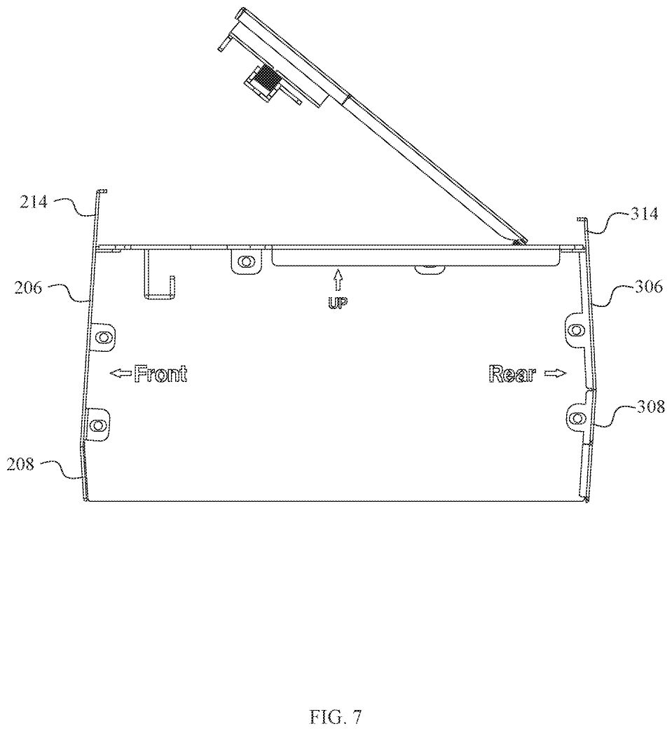

The front panel 200 is configured to attach to the front side of the center console storage compartment. It should be noted that the front panel 200 can be of any shape, size, material, features, type or kind, orientation, location, quantity, components, and arrangements of components that would allow the present invention to fulfill the objectives and intents of the present invention. In a preferred embodiment, the front panel 200 further comprises a front cutout 210. The front cutout 210 can effectively save material cost and reduce the overall weight of the locking safe. The front cutout 210 is preferably located at the central portion of the front panel 200 to keep structural integrity of the rear panel 300. In one embodiment, the front panel 200 further comprises a top portion 206 and a bottom portion 208. As illustrated in FIGS. 6 and 7, the top portion 206 is inclined outward from the top end 202 of the front panel 200, while the bottom portion 208 is inclined outward from the bottom end 204 of the front panel 200. It should be noted that it is possible that only one or neither one of the top portion 206 and bottom portion 208 of the front panel 200 is inclined outward, depending on the interior contour of the center console storage compartment. In one embodiment, the front panel 200 further comprises a front side extension 212 that extends sideward from the bottom end 204 of the front panel 200, adjacent to the side panel 400. The front side extension 212 preferably extends to a sidewall of the center console storage compartment such that the front panel 200 of the locking safe of the present invention is prevented from moving sideward after installation. In one embodiment, the front panel 200 further comprises a front top extension 214 that extends upward from the top end 202 of the front panel 200. The front top extension 214 preferably extends to the top of the center console storage compartment such that the front panel 200 of the locking safe of the present invention is prevented from moving up or down after installation. In this way, the front panel 200 can be held in position without additional fastening means.

The rear panel 300 is configured to attach to the rear side of the center console storage compartment. It should be noted that the rear panel 300 can be of any shape, size, material, features, type or kind, orientation, location, quantity, components, and arrangements of components that would allow the present invention to fulfill the objectives and intents of the present invention. In a preferred embodiment, similar to the front panel 200, the rear panel 300 further comprises a rear cutout 310 to save material cost and reduce the overall weight of the locking safe. The rear cutout 310 is preferably located at the central portion of the rear panel 300 to keep structural integrity of the rear panel 300. In one embodiment, the rear panel 300 further comprises a top portion 306 and a bottom portion 308. As illustrated in FIGS. 6 and 7, the top portion 306 is inclined outward from the top end 302 of the rear panel 300, while the bottom portion 308 is inclined outward from the bottom end 304 of the rear panel 300. It should be noted that it is possible that only one or neither one of the top portion 306 and bottom portion 308 of the rear panel 300 is inclined outward, depending on the interior contour of the center console storage compartment. In one embodiment, the rear panel 300 further comprises a rear side extension 312 that extends sideward from the bottom end 304 of the rear panel 300, adjacent to the side panel 400. The rear side extension 312 preferably extends to a sidewall of the center console storage compartment such that the rear panel 300 of the locking safe of the present invention is prevented from moving sideward after installation. In one embodiment, the rear panel 300 further comprises a rear top extension 314 that extends upward from the top end 302 of the rear panel 300. The rear top extension 314 preferably extends to the top of the center console storage compartment such that the rear panel 300 of the locking safe of the present invention is prevented from moving up or down after installation. In this way, the rear panel 300 can be held in position without additional fastening means. The front side extension 212, the front top extension 214, the rear side extension 312, and the rear top extension 314 together securely hold the locking safe of the present invention in position.

The side panel 400 is configured to form a sidewall of the locking safe. It should be noted that the side panel 400 can be of any shape, size, material, features, type or kind, orientation, location, quantity, components, and arrangements of components that would allow the present invention to fulfill the objectives and intents of the present invention. The side panel 400 comprises a top end 402, a bottom end 404, a font end 406, and a rear end 408. The top end 402, the font end 406, and the rear end 408 being attached to lateral ends of the top panel 100, the front panel 200, and the rear panel 300, respectively, to form an accommodation space 120. The attachment may be achieved by any suitable means, including but not limited to adhesives, mechanical fasteners (e.g., screws, nuts, bolts, etc.), welding, etc. The bottom end 404 of the side panel 400 is brought into contact with the bottom wall of the center console storage compartment. The top panel 100, the front panel 200, the rear panel 300, the side panel 400, together with the sidewalls and bottom wall of the center console storage compartment, enclose the accommodation space 120. In this way, the valuables of the user can be securely stored in the accommodation space 120. Although in the illustrated embodiment, the top panel 100, the front panel 200, the rear panel 300, and the side panel 400 are formed in the shape of a substantially rectangular cube, other shapes are also contemplated.

The locking safe of the present invention can be securely attached to the console without the need for additional fasteners. In an example, the front panel 200 and the rear panel 300 can be arranged in position first. Preferably, the front panel 200 and the rear panel 300 may be placed in position with the aid of adhesives (e.g., double sided adhesive tape). Then the side panel 400 may be attached to the lateral ends of the front panel 200 and rear panel 300. Lastly, the top panel 100 may be attached to the front panel 200, rear panel 300, and side panel 400 to form the enclosed accommodation space 120. In the present invention, the overall height of the locking safe and the distinct installation method allow the tray of the central console to be placed over the locking safe and slide in an unhindered manner.

Moreover, the present invention may be made of any suitable material that is durable, rigid, fire- and moisture-resistant, including but not limited to metals. It should be understood that the components of the present invention may or may not be made of the same material. Further, it is envisioned that the sizes of the components forming the present invention such as the top panel 100, the front panel 200, the rear panel 300, and/or the side panel 400 can vary based on design requirements.

Although the disclosure has been explained in relation to its preferred embodiment, it is to be understood that many other possible modifications and variations can be made without departing from the spirit and scope of the disclosure.

What is claimed is:

1. An in-vehicle locking safe comprising:
a top panel;
a front panel;
a rear panel;
a side panel;
the top panel comprising a front end and a rear end;
the front panel comprising a top end and a bottom end;
the rear panel comprising a top end and a bottom end;
the side panel comprising a top end, a bottom end, a font end, and a rear end;
the front end of the top panel being attached to the top end of the front panel;
the rear end of the top panel being attached to the top end of the rear panel;
the top end, the font end, and the rear end being attached to lateral ends of the top panel, the front panel, and the rear panel, respectively, to form an accommodation space; and
the top panel further comprising a lid.

2. The in-vehicle locking safe as claimed in claim 1, wherein the lid further comprises a locking mechanism.

3. The in-vehicle locking safe as claimed in claim 1, wherein the top panel further comprises a front portion and a rear portion, and the front portion tapers toward the front end of the top panel.

4. The in-vehicle locking safe as claimed in claim 1, wherein the front panel further comprises a front cutout.

5. The in-vehicle locking safe as claimed in claim 1, wherein the front panel further comprises a top portion and a bottom portion, and wherein the top portion is inclined outward from the top end of the front panel, while the bottom portion is inclined outward from the bottom end of the front panel.

6. The in-vehicle locking safe as claimed in claim 1, wherein the front panel further comprises a front side extension that extends sideward from the bottom end of the front panel, adjacent to the side panel.

7. The in-vehicle locking safe as claimed in claim 1, wherein the front panel further comprises a front top extension that extends upward from the top end of the front panel.

8. The in-vehicle locking safe as claimed in claim 1, wherein the rear panel further comprises a rear cutout.

9. The in-vehicle locking safe as claimed in claim 1, wherein the rear panel further comprises a top portion and a bottom portion, and wherein the top portion is inclined outward from the top end of the rear panel, while the bottom portion is inclined outward from the bottom end of the rear panel.

10. The in-vehicle locking safe as claimed in claim 1, wherein the rear panel further comprises a rear side extension that extends sideward from the bottom end of the rear panel, adjacent to the side panel.

11. The in-vehicle locking safe as claimed in claim 1, wherein the rear panel further comprises a rear top extension that extends upward from the top end of the rear panel.

12. An in-vehicle locking safe comprising:
a top panel;
a front panel;
a rear panel;
a side panel;
the top panel comprising a front end and a rear end;
the front panel comprising a top end and a bottom end;
the rear panel comprising a top end and a bottom end;
the side panel comprising a top end, a bottom end, a font end, and a rear end;
the front end of the top panel being attached to the top end of the front panel;
the rear end of the top panel being attached to the top end of the rear panel;
the top end, the font end, and the rear end being attached to lateral ends of the top panel, the front panel, and the rear panel, respectively, to form an accommodation space;
the top panel further comprising a lid;
the lid further comprising a locking mechanism;
the front panel further comprising a front cutout; and
the rear panel further comprising a rear cutout.

13. The in-vehicle locking safe as claimed in claim 12, wherein the top panel further comprises a front portion and a rear portion, and the front portion tapers toward the front end of the top panel.

14. The in-vehicle locking safe as claimed in claim 13, wherein the front panel further comprises a top portion and a bottom portion, and wherein the top portion is inclined outward from the top end of the front panel, while the bottom portion is inclined outward from the bottom end of the front panel.

15. The in-vehicle locking safe as claimed in claim 14, wherein the front panel further comprises a front side extension that extends sideward from the bottom end of the front panel, adjacent to the side panel.

16. The in-vehicle locking safe as claimed in claim 15, wherein the front panel further comprises a front top extension that extends upward from the top end of the front panel.

17. The in-vehicle locking safe as claimed in claim 12, wherein the rear panel further comprises a top portion and a bottom portion, and wherein the top portion is inclined outward from the top end of the rear panel, while the bottom portion is inclined outward from the bottom end of the rear panel.

18. The in-vehicle locking safe as claimed in claim 17, wherein the rear panel further comprises a rear side extension that extends sideward from the bottom end of the rear panel, adjacent to the side panel.

19. The in-vehicle locking safe as claimed in claim 18, wherein the rear panel further comprises a rear top extension that extends upward from the top end of the rear panel.
